(19) United States
(12) Patent Application Publication
(10) Pub. No.: US 2013/0322201 A1
(43) Pub. Date: Dec. 5, 2013

(54) COMPOUNDING APPARATUS AND METHOD

(71) Applicants: James R. Hitchcock, Deer Park, IL (US); Edward J. Anesi, Carol Stream, IL (US)

(72) Inventors: James R. Hitchcock, Deer Park, IL (US); Edward J. Anesi, Carol Stream, IL (US)

(21) Appl. No.: 13/675,601

(22) Filed: Nov. 13, 2012

Related U.S. Application Data
(60) Provisional application No. 61/629,009, filed on Nov. 12, 2011.

(51) Int. Cl. B01F 15/00

(52) U.S. Cl. CPC B01F 15/00428
USPC 366/141; 366/182.2

(57) ABSTRACT

Compounding apparatus and methods are provided for accurately compounding multiple source solutions in an efficient and automated manner. Liquids are transferred from their respective source solution containers to a common mixing chamber by pumps which are disposed between the source solution containers and the mixing chamber and fluidly connected to respective source solutions, and a controller which controls the pumps to operate in either fluid pumping mode or air pumping mode based at least in part on signals received from weight indicating devices associated with the tubing which extends between the pumps and the mixing chamber and/or weight indicating devices associated with the mixing chamber.

### CROSS REFERENCE TO RELATED APPLICATIONS

This application claims priority to U.S. Provisional patent application Ser. No. 13/675,601 filed with the U.S. Patent and Trademark Office on Nov. 13, 2012.

### STATEMENT REGARDING FEDERALLY SPONSORED RESEARCH OR DEVELOPMENT

Not Applicable

### BACKGROUND OF THE INVENTION

The present invention pertains to apparatus and methods for compounding of liquid medicines intended to be administered to humans and/or animals, and also pertains to apparatus and methods for accurately mixing controlled amounts of two or more liquids for a wide variety of applications.

### BRIEF SUMMARY OF THE INVENTION

A compounding apparatus is provided for mixing desired amounts of two or more liquids from respective source containers, in which the apparatus comprises a plurality of pumps, each fluidly connected to a respective source container, and each fluidly connected to a source of air, with each pump operable in a liquid pumping mode for pumping liquid from its respective source container, and an air pumping mode for pumping air. A mixing chamber is fluidly connected to each of the pumps for receiving the liquid pumped from all of the respective pumps, with mixing chamber supply tubing fluidly connecting the pumps with the mixing chamber. Weight indicating devices are operatively associated with each of the respective mixing chamber supply tubings for detecting a respective weight change in each of the mixing chamber supply tubings which is characteristic of the amount of liquid which has been pumped into the respective mixing chamber supply tubings. A controller is utilized which is operatively coupled to each of the pumps and the weight indicating devices for receiving signals indicative of the change in weight of each of the respective mixing chamber supply tubings and controlling the operation of the pumps at least in part responsive thereto. Methods for compounding two or more liquids are also provided which utilize pumps, mixing chambers and controller to achieve accurate and reliable compounding of many liquids, including pharmaceuticals. The invention lends itself to sterile pharmaceutical compounding.

### BRIEF DESCRIPTION OF THE DRAWING

FIG. 1 is a schematic drawing of a compounding apparatus illustrating various potential aspects of the present invention.

### DETAILED DESCRIPTION OF THE INVENTION

Although the present invention lends itself to a wide variety of applications, the invention will be explained by way of a liquid drug compounding application, and more particularly with reference to pharmaceutical compounding.

Pharmaceutical compounding generally involves the accurate transfer of specific quantities of two or more liquids from respective source containers into a final solution container, which is then brought to a recipient for suitable administration to the recipient, such as intravenously to humans or animals.

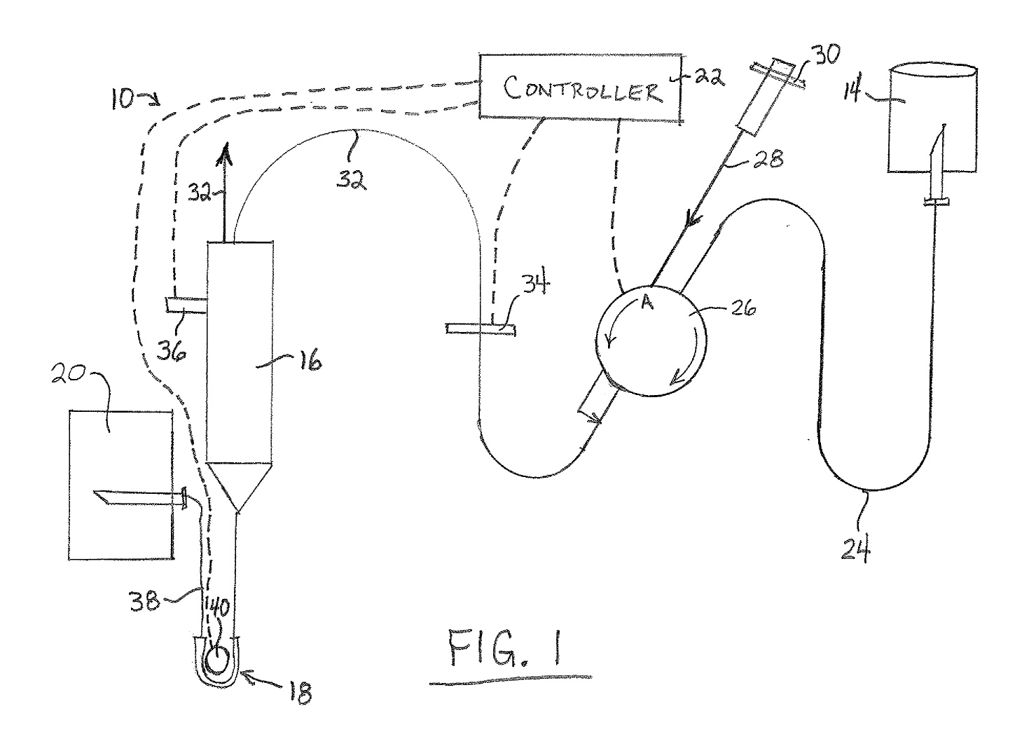

In accordance with the illustrated embodiment shown in FIG. 1, the compounding apparatus 10 may include three principal components: 1) a solution mixing or compounding portion 12 which couples containers of source solutions 14 to be mixed or compounded to a mixing chamber 16; 2) a transfer set portion 18 which couples the mixing chamber 16 to a final solution container 20; and a controller 22 for controlling the compounding or solution mixing of the apparatus 10.

The invention lends itself to use as a sterile pharmaceutical compounding apparatus.

A plurality of source containers 14 of liquids, two or more of which are to be mixed together in accurate quantities, are provided. A respective solution mixing transfer tubing 24 extends from each source solution container 14 to a pump 26 for pumping the liquids from the respective source solution containers 14 to which the pumps 26 are respectively connected. The pumps 26 are each also connected to a source of air 28 (preferably filtered air to maximize sanitation and sterilization, such as through a microfilter 30). The pumps 26 are preferably peristaltic pumps, and more preferably are pumps which are capable of operating in two distinct modes: a first liquid pumping mode in which the pump pumps the liquid from its respective source container 14; and a second air pumping mode in which the pump pumps air from the air source. One or more controllers 22 are preferably operatively connected to the pumps 26 to control their operation, both on and off as well as between liquid pumping mode and air pumping mode as will be explained in greater detail below.

The pumps 26 are also each connected to a mixing chamber supply tubing 32 which extends between each respective pump 26 and a single, common mixing chamber 16. Each of the respective mixing chamber supply tubings 32 have a load cell 34 or other weight indicating device operatively associated with such tubing 32.

When liquid is pumped by the pump 26 into the mixing chamber supply tubing 32, the load cell or other weight indicating device which is operatively associated with such mixing chamber supply tubing 32 is able to detect a weight change characteristic of the amount of liquid which has been pumped or transferred to the mixing chamber supply tubing 32. The load cell or other weight indicating device 34 is operatively connected to the controller 22 such that the controller 22 receives a signal from the load cell or other weight indicating device representative of the amount of liquid which has been pumped or transferred to the mixing chamber supply tubing 34.

Two or more of such solution mixing or compounding portions 12 provide liquid transfer from respective source solution containers 14 to the common mixing chamber 16, with each solution mixing or compounding portion having a respective pump 26 and load cell 34 operatively connected therewith and operatively connected to the controller 22.

In accordance with one aspect of the present invention, two or more pumps 26 may be actuated by the controller 22 to deliver respective predetermined quantities of liquid from respective source solution containers 14 into respective mixing chamber supply tubing 32 with the pumps being operated in their liquid pumping mode (with the load cell 34 determining when the predetermined quantity of the source liquid has been provided, sending a signal indicative thereof to the controller 22 and the controller terminating operation of the pumping mode of operation of the pump 26. The controller may then operate the pump in its air pumping mode for a sufficient time to purge the mixing chamber supply tube 32 of that liquid and force the liquid into the mixing chamber 16. Thereafter, the controller 22 stops operation of the pump.

Accordingly, the solution mixing or compounding portions of the apparatus 10 may deliver highly accurate, small amounts of liquids from their respective source solution containers 14 to the mixing chamber 16. Because the apparatus 10 purges virtually all of the liquid from the mixing chamber supply tubes (after it has operated in air pumping mode) the apparatus 10 lends itself to providing such highly accurate, small amounts of liquid multiple successive times.

In accordance with another aspect of the invention, the mixing chamber 16 may be operatively connected to a load cell or other weight indicating device 36 which is also operatively connected to the controller 22.

Accordingly, the controller 22 may receive signals representative of the weight of the liquid in each mixing chamber supply tube 32 as well as signals representative of the weight of mixed liquids from the various source solution containers 14 which has accumulated in the mixing chamber 16. The controller 22 may have suitable algorithms and control for utilizing both of these signals to suitably control the pumps 26 in a proper manner for accurately mixing proper predetermined amounts of the respective source solutions into the mixing chamber. Once the controller 22 has concluded its compounding sequence, so that the mixing chamber 16 has had the desired amounts of the respective source solutions brought together in the mixing chamber 16, the controller actuates the final solution pump 40 to pump the compounded solution from the mixing chamber 16 into a final solution container 20, through the final solution tubing 38 which extends between the mixing chamber 16 and the final solution container 20.

In accordance with an aspect of the invention, after all of the liquid has been pumped from the mixing chamber 16 into the final solution container 20, none of the mixing chamber supply tubing 32 or final solution tubing 38 have any liquid in them (or at least do not have a significant enough amount of liquid remaining to fall outside an acceptable level), and the filled final solution container 20 may be disconnected and another empty final solution container to be filled may be connected to the final solution tube and the compounding operation repeated (preferably after the load cells 34 and 36 have been reset between successive operations).

The load cell 34, controller 22 and pump 26 may also provide an indication when a source solution container 14 has become empty. When the controller 22 is operating a pump 26 in liquid pumping mode but the respective load cell 34 associated with the mixing chamber supply tubing 32 into which the liquid is being pumped by the pump 26 does not send a signal to the controller 22 representative of an increasing weight, then the controller may provide a signal warning the user that a source solution container 14 is empty. The controller 22 may indicate which specific source solution container 14 is empty to facilitate quick change-out of a new, full source solution container 14 by the operator—or automatically change out the source solution container.

As liquid is pumped into a mixing chamber supply tubing 32, the liquid in the tubing 32 may increase the weight imparted to not only that mixing chamber supply tubing 32 itself (and sensed by the load cell 34), but also may increase the weight imparted to the mixing chamber 16 (and sensed by the load cell 36 associated with the mixing chamber 16). The controller is programmed to determine the amount of liquid in the respective two or more mixing chamber supply tubings 32 which lead to the mixing chamber 16 regardless of whether there is already liquid in the mixing chamber 16 or not.

For a given mixing chamber supply tubing 32 having a volume of X, if it is desired to supply a quantity of the liquid which is associated with that tubing 32 which is less than X, then the pump 26 is controlled to operate in fluid pumping mode to pump that liquid from its source solution container 14 until the weight indicating devices 34 (or 34 and 36) indicate that the desired amount of that liquid has been pumped into the mixing chamber supply tubing 32, at which time the liquid pumping mode is terminated and the air pumping mode is initiated for a time sufficient to purge all the liquid from the mixing chamber supply tubing 32 into the mixing chamber 16. This assures an accurate measurement and delivery of even small amounts of that liquid from the source solution container 14 into the mixing chamber 16.

However, for a given mixing chamber supply tubing 32 having a volume of X, if it is desired to supply a quantity of the liquid which is associated with that tubing 32 which is greater than X, then the pump 26 is controlled to operate in fluid pumping mode to pump that liquid from its source solution container 14 until the weight indicating devices 34 and 36 indicate that the desired amount of that liquid has been pumped into the mixing chamber and mixing chamber supply tubing 32, at which time the liquid pumping mode is terminated and the air pumping mode is initiated for a time sufficient to purge all the liquid from the mixing chamber supply tubing 32 into the mixing chamber 16. This assures an accurate measurement and delivery of even larger volumes than X of that liquid from the source solution container 14 into the mixing chamber 16. That is, for transferring desired volumes of a liquid greater than X to the mixing chamber (where X represents the volume of the mixing chamber supply tubing 32), the pump 26 is operated in liquid pumping mode beyond the point that the mixing chamber supply tubing 32 has been filled, after which as the pump 26 continues to be operated further in liquid pumping mode the mixing chamber 16 begins to be filled with that liquid while the mixing chamber tubing remains full of that liquid. After the weight sensing devices 34 and 36 send signals to the controller indicating that the weight of the mixing chamber and mixing chamber supply tubing achieve the desired level, the controller sends signals to change the pump to air pumping mode to force the liquid remaining in the mixing chamber supply tubing out into the mixing chamber, and thereby purge the mixing chamber supply tubing of liquid.

For multiple liquid compounds, the controller may be programmed to subtract the cumulative weights of certain liquids known to have already been transferred to the mixing chamber from the cumulative weight in the mixing chamber.

The controller may be programmed to execute one or more compounding protocols or procedures based on prescribed data entry. During operation of the apparatus of the invention, the pumps are individually, selectively operated in series as dictated by the controller, to transfer desired amounts of source solutions from the individual source solution containers to the mixing chamber, and from the mixing chamber into the final solution container. The controller monitors the signals indicative of the changes in weights of the mixing chamber supply tubes and/or mixing chamber, and operates the pumps according to predetermined or programmed sequences.

Rather than using a single pump having both liquid pumping and air pumping modes, one may use one liquid pump and a separate air pump.

Two or more controllers may be used to control the pumps.

There may be two or more mixing chambers which are then further compounded.

Although reference is made herein to controllers determining an amount of liquid, the controller may not actually determine the amount of liquid, but rather may determine the weight of liquid which corresponds to a predetermined delivery amount suitable for the particular protocol being run.

Although the inventions of the present application are set forth by way of representative examples and descriptions, the invention is not intended to be limited to the specifics set forth herein, but rather in accordance with the following claims.

What is claimed is:

1. A compounding apparatus for mixing desired amounts of two or more liquids from respective source containers, comprising:
a plurality of pumps, each fluidly connected to a respective source container, and each fluidly connected to a source of air, with each pump operable in a liquid pumping mode for pumping liquid from its respective source container, and an air pumping mode for pumping air;
a mixing chamber fluidly connected to each of the pumps for receiving the liquid pumped from all of the respective pumps;
mixing chamber supply tubing for fluidly connecting the pumps with the mixing chamber;
weight indicating devices operatively associated with each of the respective mixing chamber supply tubings for detecting a respective weight change in each of the mixing chamber supply tubings which is characteristic of the amount of liquid which has been pumped into the respective mixing chamber supply tubings; and
a controller operatively coupled to each of the pumps and the weight indicating devices for receiving signals indicative of the change in weight of each of the respective mixing chamber supply tubings and controlling the operation of the pump at least in part responsive thereto.

2. A compounding apparatus in accordance with claim 1 in which the mixing chamber has a weight indicating device operatively associated therewith which sends signals to the controller for detecting a weight change in the fluid in the mixing chamber which is characteristic of the amount of liquid which has been pumped into the mixing chamber, with the weight indicating device associated with the mixing chamber operatively connected to the controller, and the controller controlling the pump based at least in part on signals from both the weight indicating device associated with the mixing chamber and the weight indicating devices associated with the mixing chamber supply tubings.

3. A compounding apparatus in accordance with claim 2 in which the weight indicating device operatively associated with the mixing chamber supply tubing is more accurate than the weight indicating device operatively associated with the mixing chamber.

4. A compounding apparatus in accordance with claim 1 in which the pumps are peristaltic pumps.

5. A compounding apparatus in accordance with claim 1 in which a final solution container is fluidly connected with the mixing chamber for receiving the fluid from the mixing chamber after the respective predetermined amounts of source solutions have been brought together into the mixing chamber.

6. A compounding apparatus in accordance with claim 5 in which a final solution pump pumps the liquid solution from the mixing chamber to the final solution container.

7. A compounding apparatus in accordance with claim 6 in which the final solution pump is operatively connected to the controller and actuated by the controller after the controller determines that the respective predetermined amounts of source solutions have been brought together into the mixing chamber.

8. A compounding apparatus in accordance with claim 6 in which the final solution pump is operable in a first mode to pump fluid from the mixing chamber to the final solution container and a second mode to pump fluid from the final solution container to the mixing chamber.

9. A compounding apparatus in accordance with claim 1 in which the weight indicating devices are load cells.

10. A method of compounding a plurality of liquids, the method comprising:
providing a plurality of liquids to be compounded each in respective source solution containers;
fluidly connecting each of the source solutions containers to respective pumps which are operable in a fluid pumping mode and an air pumping mode;
providing a mixing chamber fluidly connected to the pumps via respective mixing chamber supply tubing for receiving the fluids from the pumps;
providing weight indicating devices operatively associated with respective mixing chamber supply tubings for sending signals indicative of the weight change of the tubings which varies with the amount of liquid in the tubings;
providing a controller operatively connected with the pumps and the one or more weight indicating devices;
initiating liquid pumping mode operation of the pumps which are fluidly connected to the source solution containers containing the liquids to be compounded;
stopping pumping mode operation of the respective pumps when their respective weight indicating devices have sent signals to the controller indicating that the predetermined amount of the respective liquid from its associated source solution container liquid has been pumped into the mixing chamber supply tubing; and
initiating air pumping mode operation of each of the respective pumps to force all the liquid in each respective mixing chamber supply tubing into the mixing chamber and to purge the mixing chamber supply tubings of their respective liquids.

11. The method in accordance with claim 10 further comprising:
providing a weight indicating device operatively associated with the mixing chamber for sending signals indicative of the weight change of the mixing chamber which varies with the amount of liquid in the weight chamber.

12. The method in accordance with claim 10 in which the controller utilizes signals received from both a weight indicating device associated with the mixing chamber and weight indicating devices associated with two or more mixing chamber supply tubes in its controlling of the pumps.

13. The method in accordance with claim 10 in which the pumps are operated in series.

14. The method in accordance with claim 10 in which the weight indicating devices are load cells.

15. The method in accordance with claim 10 in which the controller sends a signal suitable for actuating an alarm when it is controlling the pump to operate in liquid pumping mode and the weight indicating device associated with the mixing chamber supply tubing does not change.

16. The method in accordance with claim 10 in which the controller sends a signal suitable for actuating an alarm when it is controlling the pump to operate in liquid pumping mode and the weight indicating devices associated with both the mixing chamber supply tubing and the mixing chamber do not change.

17. A compounding apparatus, comprising:
a plurality of pumps fluidly connectable with respective source solution containers;
a mixing chamber fluidly connected with each of said pumps;
the pumps being operable in a fluid pumping mode to pump fluid from the respective source solution container to the mixing chamber, and being operable in an air pumping mode to subsequently pump air to the mixing chamber to assure all fluid between the pumps and the mixing chamber is purged.

18. A compounding apparatus in accordance with claim 17 in which a controller is operably connected to the pumps to carryout predetermined compounding sequences.

19. A compounding apparatus in accordance with claim 18 in which tubing extends between each pump and the mixing chamber, and one or both of the tubings and mixing chamber have weight change detecting devices associated therewith for detecting weight changes corresponding to changes in volumes of liquids pumped by the pumps, with the weight change detection devices being operatively connected to the controller, and the controller controlling the operation of the pumps at least in part based on detected changes in weight of one or both of the tubings and mixing chamber.

20. A compounding apparatus in accordance with claim 19 in which the mixing chamber is fluidly connectable with a final solution container for receiving the compounded mixture of liquids from the mixing chamber.
